(19) United States
(12) Patent Application Publication
(10) Pub. No.: US 2016/0087342 A1
(43) Pub. Date: Mar. 24, 2016

(54) CIRCUIT-LOADED CONFORMAL METASURFACE CLOAK

(71) Applicant: BOARD OF REGENTS, THE UNIVERSITY OF TEXAS SYSTEM, Austin, TX (US)

(72) Inventors: Andrea ALU, Austin, TX (US); Jason SORIC, Austin, TX (US); Pai-Yen CHEN, Austin, TX (US)

(73) Assignee: Board of Regents, The University of Texas System

(21) Appl. No.: 14/889,679

(22) PCT Filed: Apr. 8, 2014
(86) PCT No.: PCT/US2014/033292

§ 371 Date: Nov. 6, 2015

Related U.S. Application Data
(60) Provisional application No. 61/820,224, filed on May 7, 2013.

(51) Int. Cl. H01Q 17/00

(52) U.S. Cl. CPC H01Q 17/007; H01Q 17/008

(57) ABSTRACT

An electromagnetic invisibility cloaking device with a broadened cloaking bandwidth and/or a tunable frequency of operation. The cloaking device includes an object (e.g., antenna) and a metasurface (301) that conforms to the surface design of the object. The metasurface includes an array of metal cells (302A, . . . , 302Y), where each of the metal cells includes a circuit element (304) (e.g., active, passive, negative impedance converter element). The array of metal cells may be represented as an array of metal square patches, a mesh grid, horizontal or vertical conductive strips, or any arbitrary combination of unit cell patterns, where each opening, or a subset of them, in such an array includes an embedded circuit element. By incorporating the circuit elements in the conformal metasurface, the cloaking bandwidth is broadened and the frequency of operation is actively controlled and tuned.

### CROSS REFERENCE TO RELATED APPLICATIONS

This application claims priority to U.S. Provisional Patent Application Ser. No. 61/820,224, “Broadening Mantle Cloak Using Non-Foster Metamaterial Surfaces,” filed on May 7, 2013, which is incorporated by reference herein in its entirety.

### GOVERNMENT INTERESTS

The U.S. Government has certain rights in this invention pursuant to the terms of the National Science Foundation Grant No. ECCS-0953311; Air Force Office of Scientific Research Grant No. FA9550-11-1-0009; and Defense Threat Reduction Agency Young Investigator Program Grant No. HDTRA1-12-1-0022.

### TECHNICAL FIELD

The present invention relates generally to electromagnetic invisibility cloaks, and more particularly to broadening the cloaking bandwidth by incorporating circuit elements in a conformal metasurface cloak.

### BACKGROUND

In recent years, there has been an increased interest in the study of electromagnetic invisibility cloaks due to their promising applications in camouflaging, non-invasive probing, high-fidelity biomedical measurements, low-noise and low-interference radio and antenna communications, optical tagging, nonlinear nanodevices and scattering signature manipulation. Various techniques have been put forward to achieve invisibility, among which are the transformation coordinate techniques and plasmonic cloaking. Recently, a different cloaking technique based on the concept of “mantle cloaking” has been proposed to reduce the visibility of various types of objects. In this technique, scattering cancellation is obtained using a conformal metasurface, rather than a bulk metamaterial (artificial material engineered to have properties that may not be found in nature), with the same effect of drastically reducing the overall scattering from a given object.

In “mantle cloaking,” a suitably designed metasurface supports current distributions radiating “anti-phase” fields that cancel the scattering from the covered object. Mantle cloaks can be readily realized at microwaves by patterning a metallic surface around the object of interest, and various structural designs have been proposed in the context of metasurfaces and frequency-selective surfaces (FSS). It has been recently shown that even a one-atom-thick graphene monolayer may achieve scattering suppression at THz frequencies. The ultrathin profile of mantle cloaks makes their practical realization easier than bulk metamaterial cloaks, and it is also usually associated with a moderate bandwidth improvement compared with the other cloaking techniques based on bulk metamaterials. Still, similar bandwidth limitations apply to the current implementation of mantle cloaks, and they are fundamentally related to the passivity of these designs. Achieving broadband cloaks, on the contrary, may finally bring electromagnetic invisibility cloaks within the realm of practical realization.

### BRIEF SUMMARY

In one embodiment of the present invention, an electromagnetic invisibility cloaking device comprises an object and a metasurface comprising an array of metal cells. One or more of the metal cells comprises a circuit element. Furthermore, the metasurface conforms to a surface design of the object.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a mantle cloak designed for a dielectric infinite cylinder under transverse-magnetic (TM) illumination in accordance with an embodiment of the present invention;

FIG. 2A is a graph illustrating the variation of the surface reactance for an optimal (non-Foster) mantle cloak, a passive mantle cloak designed to cloak at the design frequency f₀, and a negative impedance converter (NIC)-loaded cloak in accordance with an embodiment of the present invention;

FIG. 2B is a graph illustrating the variation of the normalized scattering width (SW) for the dielectric cylinder of FIG. 1 covered by the cloaks in FIG. 2A in accordance with an embodiment of the present invention;

FIGS. 3A-3C illustrate an electromagnetic invisibility cloaking device that includes a passive metasurface made of an array of patterned inclusions loaded by circuit elements that conforms to a surface design of an object in accordance with an embodiment of the present invention;

FIG. 4A illustrates a view of a patch or a horizontal strip array of the metal cells in accordance with an embodiment of the present invention;

FIG. 4B illustrates the array of the metal cells loaded with a series combination of the loads in accordance with an embodiment of the present invention;

FIGS. 5A-5B illustrate the far-field scatting pattern of the infinite dielectric cylinder of FIG. 1 without cover, with the ideal non-Foster mantle cloak, with the NIC-loaded mantle cloak and with the ideal passive cloak for different frequencies of operation: 0.8 GHz, 0.65 GHz, 0.5 GHz and 0.4 GHz in accordance with an embodiment of the present invention;

FIG. 6A is a schematic diagram of the time-domain analysis of a cloaked cylinder in accordance with an embodiment of the present invention;

FIGS. 6B-6D are graphs illustrating the signals detected by the receivers placed in different positions along the z axis, considering the cases of: no cloak, NIC-loaded mantle cloaks and the ideal passive cloak, respectively, in accordance with an embodiment of the present invention;

FIGS. 7A-7C illustrate a finite-length conductive rod covered by a metasurface loaded with tunable circuit elements in accordance with an embodiment of the present invention;

FIG. 8 is a graph illustrating an example of the wideband tunability of the cloaked finite-length conductive rod in accordance with an embodiment of the present invention; and

FIG. 9 illustrates the scattering patterns of the cloaked rod without cover and with the cloak (metasurface of FIG. 7A) by applying several voltages to the loaded surface in accordance with an embodiment of the present invention.

### DETAILED DESCRIPTION

As stated in the Background section, in “mantle cloaking,” a suitably designed metasurface supports current distributions radiating “anti-phase” fields that cancel the scattering from the covered object. Mantle cloaks can be readily realized at microwaves by patterning a metallic surface around the object of interest, and various structural designs have been proposed in the context of metasurfaces and frequency-selective surfaces (FSS). It has been recently shown that even a one-atom-thick graphene monolayer may achieve scattering suppression at THz frequencies. The ultrathin profile of mantle cloaks makes their practical realization easier than bulk metamaterial cloaks, and it is also usually associated with a moderate bandwidth improvement compared with the other cloaking techniques based on bulk metamaterials. Still, similar bandwidth limitations apply to the current implementation of mantle cloaks, and they are fundamentally related to the passivity of these designs. Achieving broadband cloaks, on the contrary, may finally bring electromagnetic invisibility cloaks within the realm of practical realization.

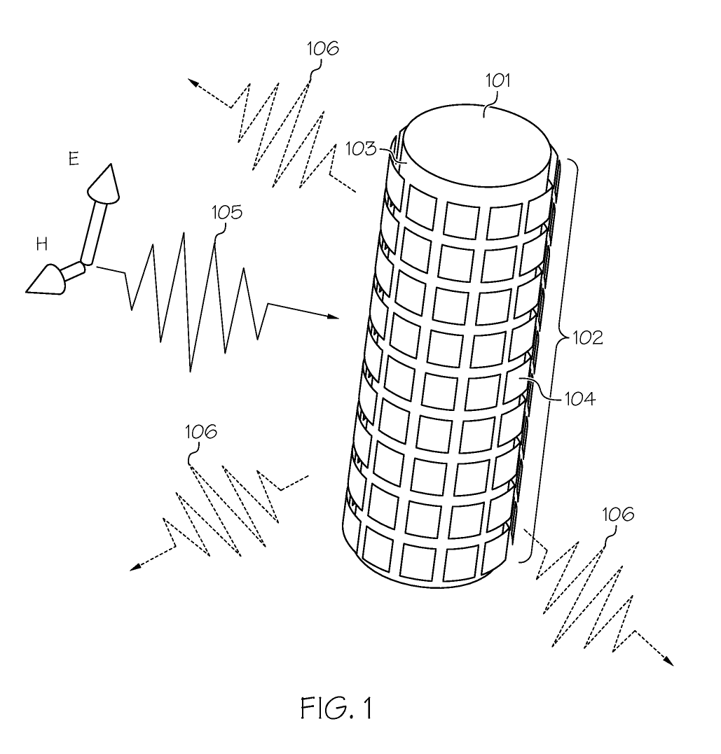

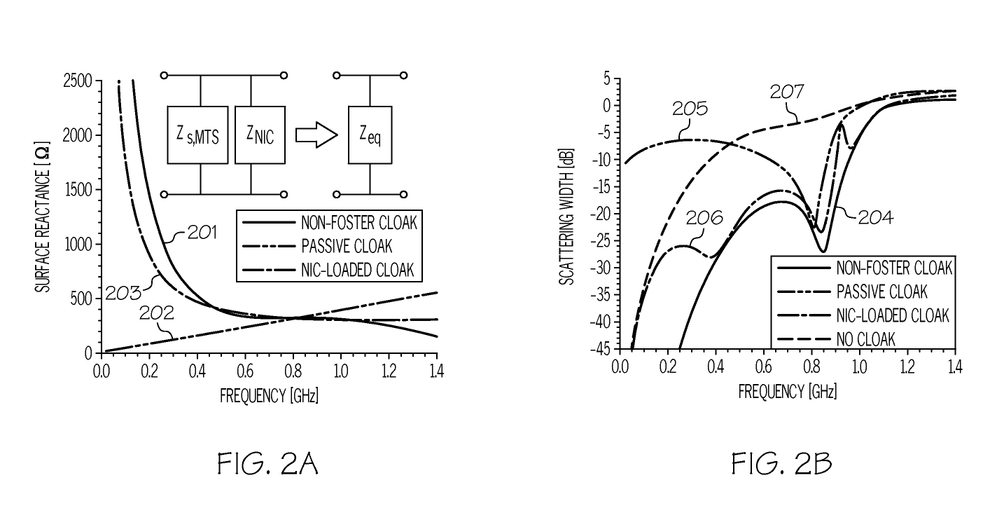

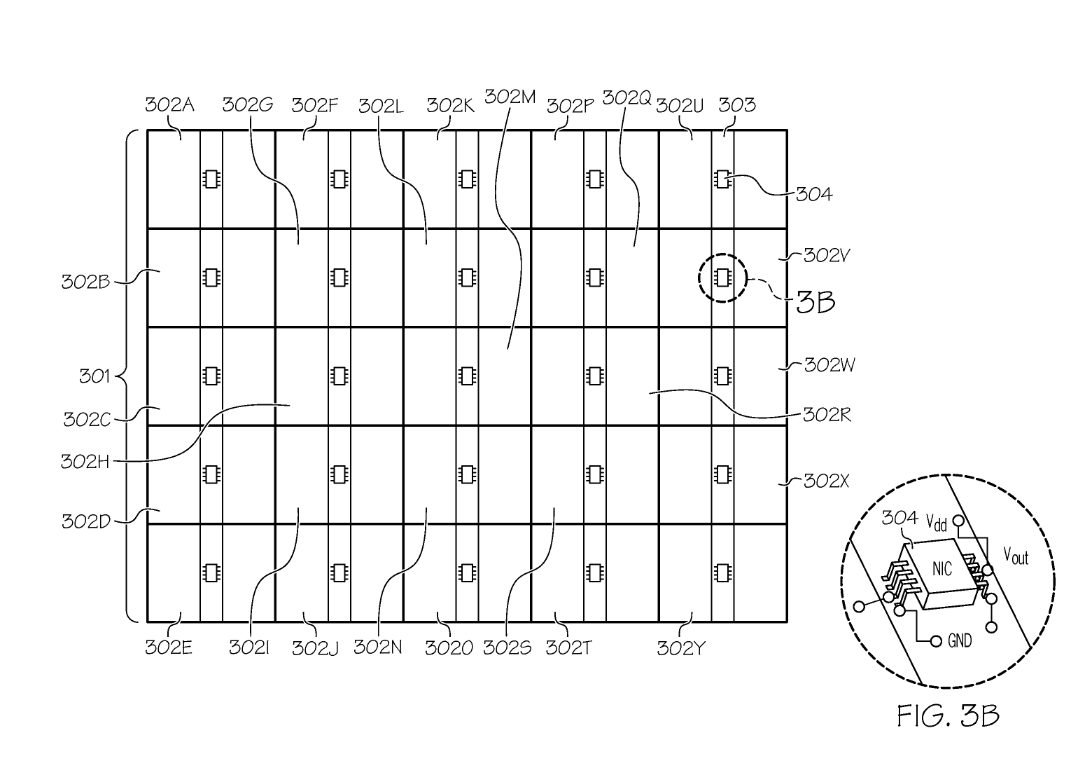

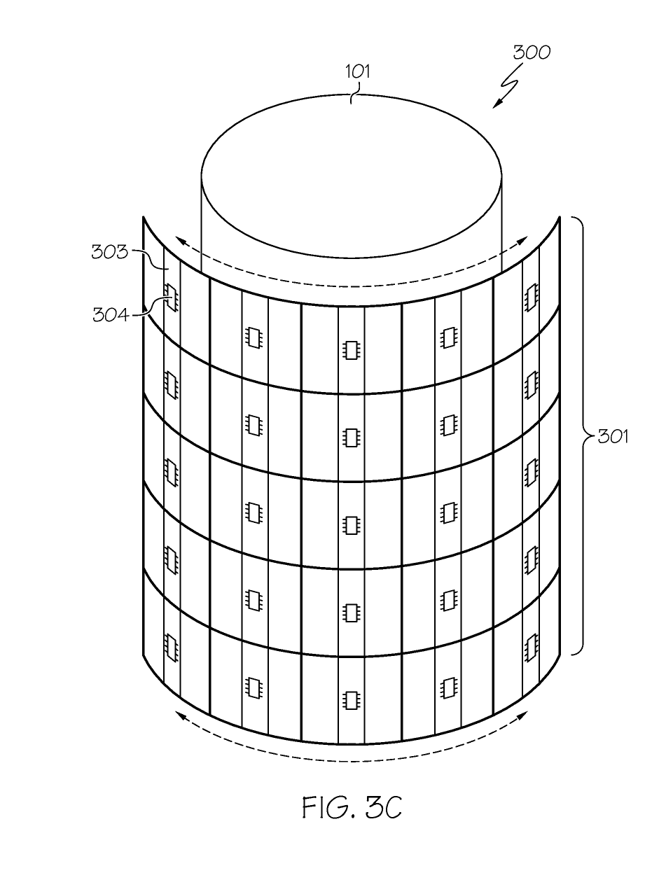

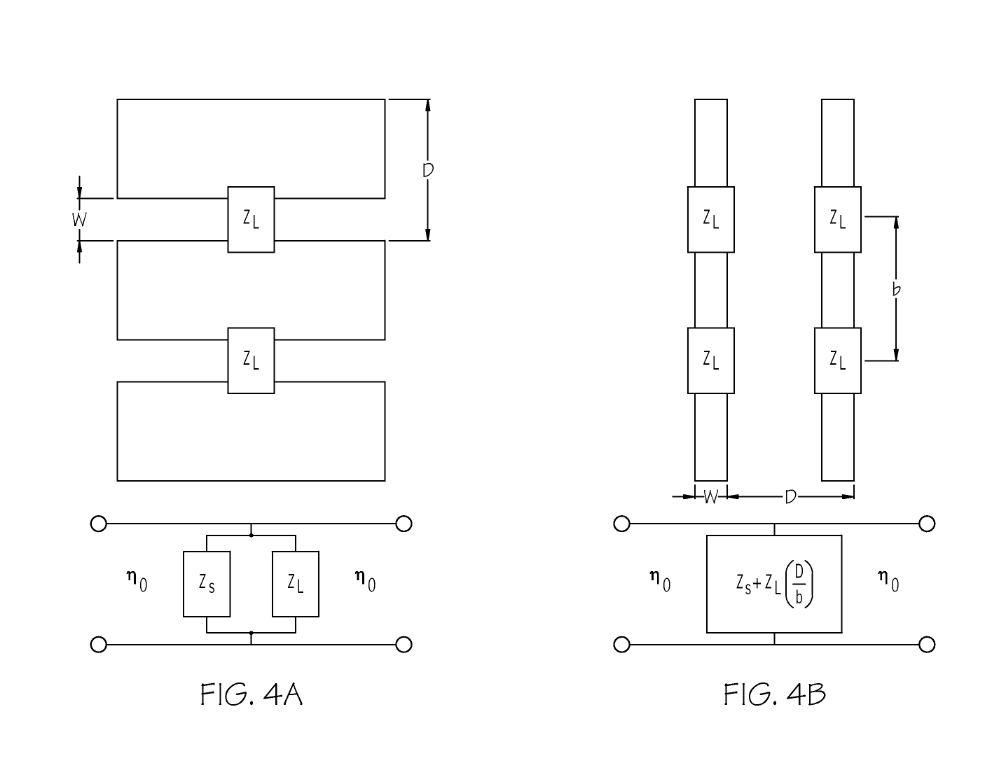

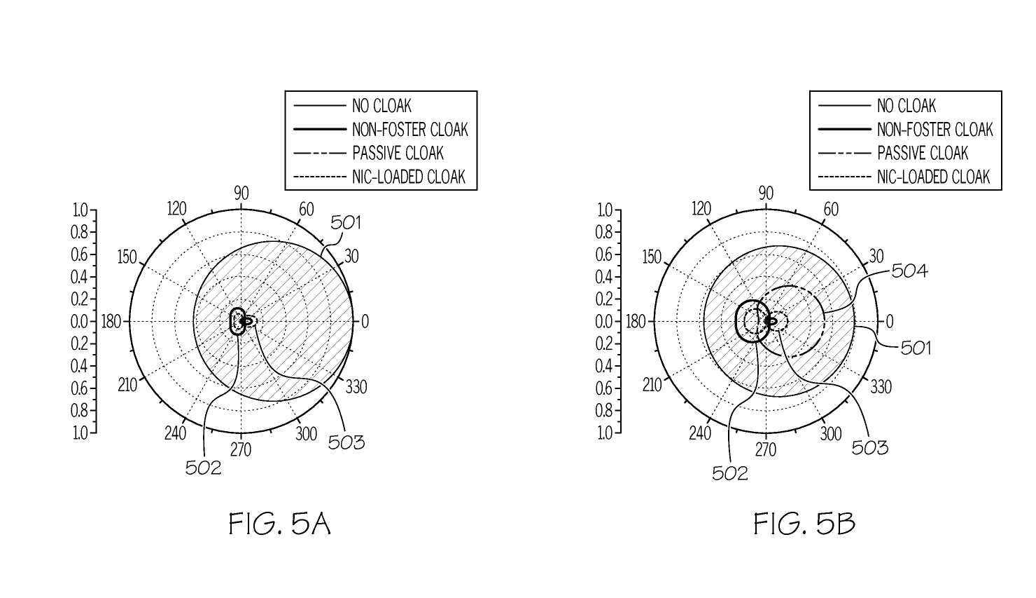

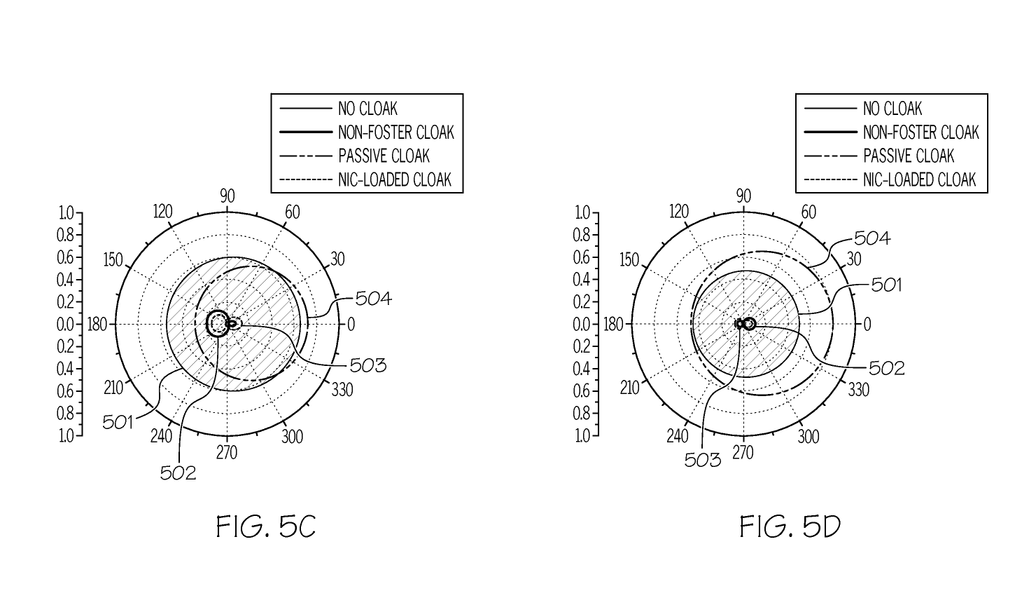

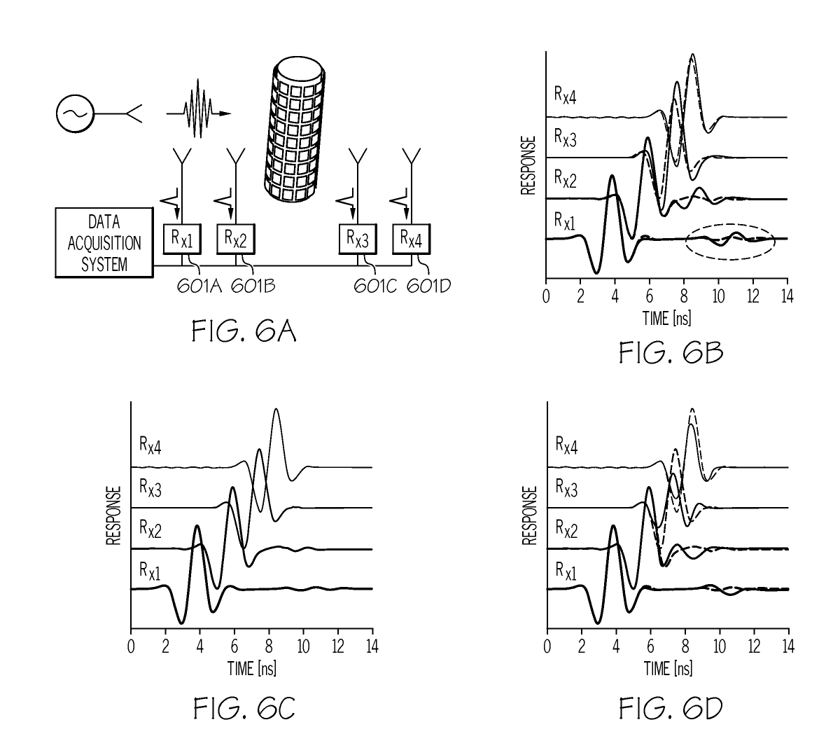

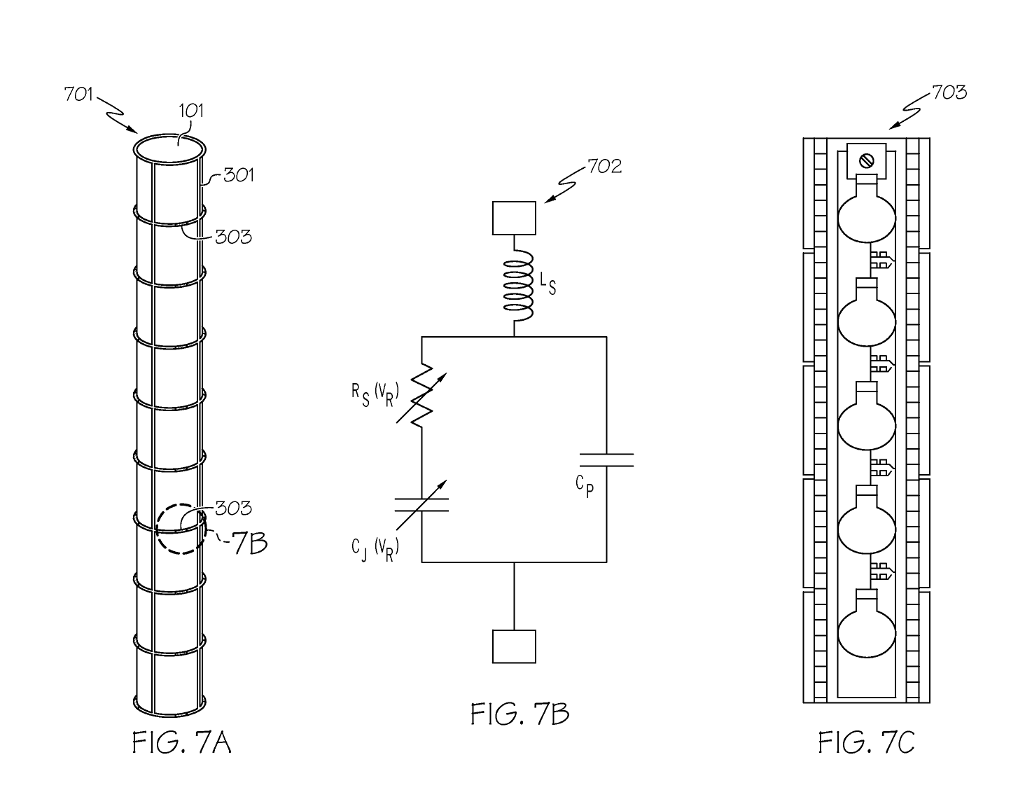

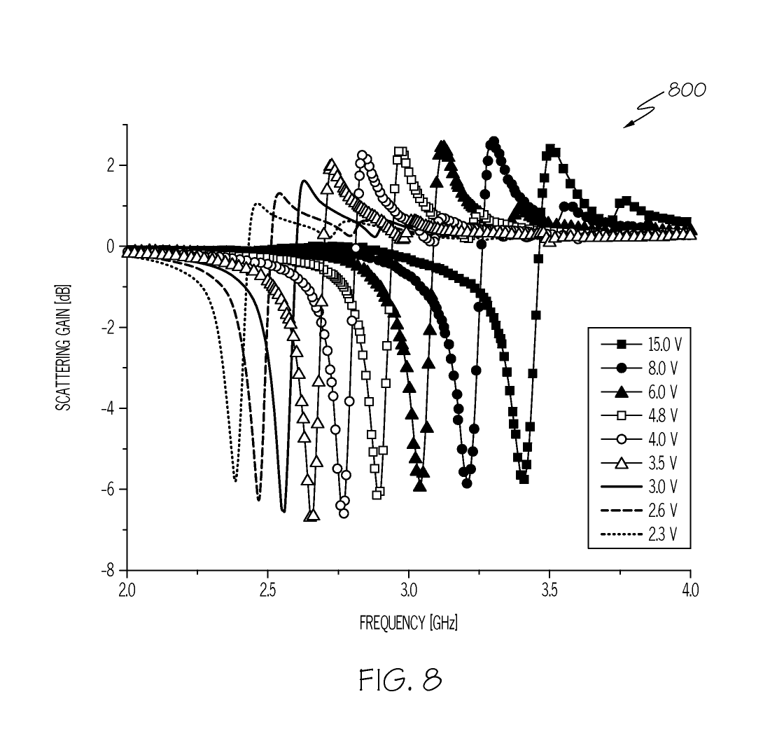

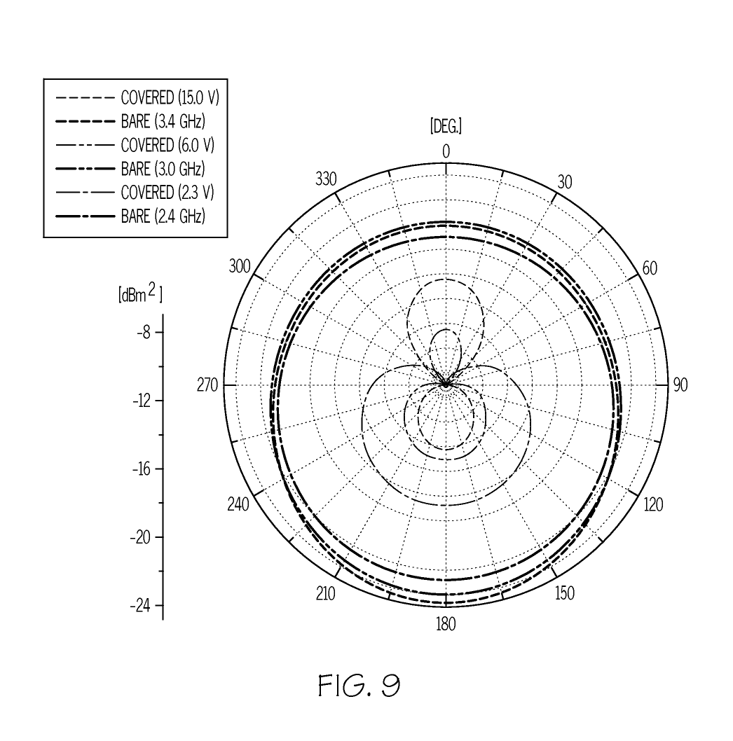

The principles of the present invention provide a means for broadening the cloaking bandwidth by incorporating circuit elements in the conformal metasurface as discussed below in connection with FIGS. 1, 2A-2B, 3A-3C, 4, 5A-5B, 6A-6D, 7A-7C and 8-9. FIG. 1 illustrates a mantle cloak designed for a dielectric infinite cylinder under transverse-magnetic (TM) illumination. FIG. 2A is a graph illustrating the variation of the surface reactance for an optimal (non-Foster) mantle cloak, a passive mantle cloak designed to cloak at the design frequency f₀, and a NIC-loaded cloak. FIG. 2B is a graph illustrating the variation of the normalized scattering width (SW) for the dielectric cylinder of FIG. 1 covered by the cloaks in FIG. 2A. FIGS. 3A-3C illustrate an electromagnetic invisibility cloaking device that includes a passive metasurface made of an array of patterned inclusions loaded by circuit elements that conforms to a surface design of an object. FIG. 4A illustrates a view of a patch or a horizontal strip array of the metal cells. FIG. 4B illustrates the array of the metal cells loaded with a series combination of the loads. FIGS. 5A-5B illustrate the far-field scatting pattern of the infinite dielectric cylinder of FIG. 1 without cover, with the ideal non-Foster mantle cloak, with the NIC-loaded mantle cloak and with the ideal passive cloak for different frequencies of operation: 0.8 GHz, 0.65 GHz, 0.5 GHz and 0.4 GHz. FIG. 6A is a schematic diagram of the time-domain analysis of a cloaked cylinder. FIGS. 6B-6D are graphs illustrating the signals detected by the receivers placed in different positions along the z axis, considering the cases of: no cloak, NIC-loaded mantle cloaks and the ideal passive cloak, respectively. FIGS. 7A-7C illustrate a finite-length conductive rod covered by a metasurface loaded with tunable circuit elements. FIG. 8 is a graph illustrating an example of the wideband tunability of the cloaked finite-length conductive rod. FIG. 9 illustrates the scattering patterns of the cloaked rod without cover and with the cloak (metasurface of FIG. 7A) by applying several voltages to the loaded surface.

In order to understand the fundamental limitations on bandwidth specifically applied to the mantle cloaking technique, consider the simple case of an infinite cylinder with relative permittivity ε=3, relative permeability μ=1 and diameter 2α=12 cm, covered by a two-dimensional conformal mantle cloak with radius α_{c} as shown in FIG. 1. As stated above, FIG. 1 illustrates a mantle cloak designed for a dielectric infinite cylinder under transverse-magnetic (TM) illumination in accordance with an embodiment of the present invention.

Referring to FIG. 1, FIG. 1 illustrates an object 101 (e.g., antenna) that is surrounded by a cloak 102 of two-dimensional sub-wavelength mesh patch with radius α_{c}. In the illustration of FIG. 1, object 101 corresponds to an infinite cylinder. In one embodiment, object 101 is made of a dielectric material 103 and the mesh patch (or metasurface) of cloak 102 is made of a combination of dielectric material 103 and metal 104. The impinging wave 105 is then scattered in various directions 106 as shown in FIG. 1.

If the periodicity of the metallic patterns of the mesh patch or metasurface of cloak 102 is smaller than the wavelength of operation, under certain symmetries of the excitation, the metasurface of cloak 102 can be described with an isotropic averaged surface impedance Zₛ=Rₛ iX _{s̅} under an e^{-iωt} time convention.

For a normally incident, transverse-magnetic (TM) plane wave with magnetic field polarized orthogonal to the cylinder axis, for which largest interaction is expected in the case of an object of moderate thickness, the Mie scattering coefficients may be written as cₙ^{TM}−Uₙ^{TM}/(Uₙ^{TM}+iVₙ^{TM}), and the total scattering width (SW) of cylinder 101 normalized to the wavelength, a quantitative measure of its overall visibility, becomes

$${σ}_{2 D} = \frac{2}{π} {\sum }_{n = 0}^{n = ∞} ( 2 {δ}_{n , 0} ) {\vert {c}_{n}^{\underline{TM}} \vert}^{2} .$$

In the long-wavelength limit, these expressions simplify, as the n=0 harmonic dominates the overall scattering, and the condition to achieve identically zero x₀^{TM} becomes

$${X}_{s} = \frac{2}{{ωαγɛ}_{0} ( ɛ - 1 )} , \qquad ( 1 )$$

where γ=α/α_{c}. This value is inductive for dielectric objects ε>1, as expected due to the capacitive nature of a moderate size dielectric cylinder. However, the frequency dispersion of the required inductance violates Foster's reactance theorem, which states that the reactance of any passive element in regions of low absorption must monotonically increase with frequency, ∂Xₛ(ω)/∂ω>0. Eq. (1) actually corresponds to a negative capacitance Zₛ=1/(−iω(−C_{eff})), with C_{eff}=ε₀(ε−1)γα/2, which may be achieved in a circuit only considering amplifiers or active elements, for which Foster's theorem does not apply. Essentially, the metasurface of cloak 102 is required to catch up with the capacitive dispersion of object 101, requiring an active loading. This is consistent with the idea of relaxing the bandwidth limitations of bulk metamaterials with the use of active inclusions.

Even if one is to intuitively expect that active inclusions may overcome the passivity constraints mentioned above, in practice, it is challenging to design a practical active metamaterial cloak realizing this effect. In the following, on the contrary, it is shown that a non-Foster mantle cloak may be realistically formed by loading a subwavelength metallic patch array with circuit elements, such as negative impedance converter (NIC) elements. The mantle cloaking technique is particularly well suited to be combined with lumped NIC elements, and allows combining a large bandwidth of operation with ultra-low profile and relatively simple realization.

Moving to the full-wave dynamic scenario, FIG. 2A is a graph illustrating the variation of the surface reactance for an optimal (non-Foster) mantle cloak (line 201), a passive mantle cloak designed to cloak at the design frequency f₀ (line 202), and a NIC-loaded cloak (line 203) in accordance with an embodiment of the present invention. Referring to FIG. 2A, FIG. 2A shows the optimal surface reactance X_{s,opt} (line 201) required to minimize the total scattering from dielectric cylinder 101 of FIG. 1 at every frequency point using a lossless mantle cloak 102 (FIG. 1) with radius α_{c}=α. The curve was calculated using the rigorous analytical formulation developed in P. Y. Chen, and A. Alu, Phys. Rev. B, 84, 205110 (2011), which is incorporated by reference herein in its entirety: it is obvious that a non-Foster dispersion is indeed required to realize broadband cloaking, as ∂X_{s,opt}(ω)/∂ω<0 over the whole frequency range of interest. First, a passive mantle cloak is assumed to be used with inductive reactance −iX_{s,MTS}=−iωL [Ω] and L=62.620 nH, designed to suppress the scattering at the design frequency f₀=0.8 GHz . Its frequency dispersion (line 202) can intersect the optimal reactance curve X_{s,opt} at one single point X_{s,FSS|f}_{₀}=314.76Ω, implying that the achievable cloaking bandwidth is intrinsically narrow, as dictated by causality and passivity. Even using a multilayered cloak, one may be able to hit the optimal curve at various frequencies, but Foster's theorem would require a scattering peak (pole) to arise in between every two zeros, inherently limiting the available cloaking bandwidth.

FIG. 2B is a graph illustrating the variation of the normalized scattering width (SW) for dielectric cylinder 101 (FIG. 1) covered by the cloaks (line 204 corresponds to the non-foster cloak; line 205 corresponds to the passive cloak; and line 206 corresponds to the NIC-loaded cloak) in FIG. 2A in accordance with an embodiment of the present invention. Referring to FIG. 2B, FIG. 2B shows the SW frequency variation for the passive cloaked cylinder (line 205), compared to the uncloaked case (dashed line 207). Indeed, the passive cloak can significantly suppress the scattering around the design frequency f₀, but only over a limited bandwidth. Moreover, at lower frequencies the cloaked cylinder generates more scattering than the uncloaked case, due to its inherent frequency dispersion.

To realize a broadband cloak, active metasurfaces may be used to break Foster's limitations. A design of such an active metasurface is described below in connection with FIGS. 3A-3C.

Referring to FIGS. 3A-3C, FIGS. 3A-3C illustrate an electromagnetic invisibility cloaking device 300 that includes a passive metasurface 301 made of an array of metal cells 302A-302Y that conforms to a surface design of an object, such as object 101 of FIG. 1, in accordance with an embodiment of the present invention. Cells 302A-302Y may collectively or individually be referred to as cells 302 or cell 302, respectively. While FIG. 3A illustrates twenty-five metal cells 302, metasurface 301 may be comprised of an array of any number of arbitrarily patterned metal cells 302. In one embodiment, each metal cell 302 may include a layer of dielectric material 303 (where a circuit element may reside as discussed further below) as depicted for the mesh patch 102 in FIG. 1. In one embodiment, the array of metal cells 302 may be represented as metal square patches. In another embodiment, the array of metal cells 302 may be represented as a mesh grid. In another embodiment, the array of metal cells 302 may be represented as horizontal or vertical conductive strips, or any arbitrary combination of unit cell patterns, where each opening, or a subset of them, in such an array includes an embedded circuit element (circuit element 304) as discussed below.

In one embodiment, each metal cell 302 (or a limited number of metal cells 302) includes a circuit element 304, whether active or passive. In one embodiment, circuit element 304 corresponds to a variable capacitor, a diode, a variable inductor or a combination of the preceding. In one embodiment, circuit element 304 corresponds to a negative impedance converter (NIC) element as shown in FIG. 3B. In one embodiment, NIC element 304 corresponds to a one-port op-amp circuit acting as a negative load which injects energy into circuits in contrast to an ordinary load that consumes energy from them. In another embodiment, NIC element 304 corresponds to any semiconductor circuit (e.g., CMOS circuit, bipolar junction transistor, discrete circuit) acting as a negative load.

While the description herein describes metasurface 301 as being made of an array of metal cells 302, metasurface 301 may be made of other designs, such as a mesh grid with a circuit element 304 in each opening.

As illustrated in FIG. 3C, metasurface 301 may then be conformed to the surface design of an object, such as an antenna or cylindrical object 101 of FIG. 1, so as to suppress the scattering from object 101 at a desired frequency of interest as discussed herein. In one embodiment, metasurface 301 wraps around object 101 with a given spacer.

Referring to FIG. 3A, in one embodiment, metasurface 301 has an array period d=1.8 cm and a gap between neighboring elements 304 of g=0.12 d. This geometry is well described by the equivalent capacitive impedance Z_{patch}^{TM}=R_{patch}+1/(−iωC_{patch}); detailed expressions for R_{patch} and C_{patch} in terms of the geometry parameters, and their applicability to mantle cloaks, are available in Y. R. Padooru, A. B. Yakovlev, P. Y. Chen, and A. Alu, Journ. Of Appl. Phys., 112, 034907 (2012), which is incorporated by reference herein in its entirety. When the gaps are loaded by lumped circuit elements Z_{NIC}, as in FIGS. 3A and 3B, the equivalent surface impedance is given by the parallel combination of the load impedance and the metasurface impedance (inset of FIG. 2(a)) Z_{s,eq}=R_{s,eq}−iX_{s,eq}=((Z_{patch}^{TM})⁻¹+(Z_{NIC})⁻¹)⁻¹. By implementing active NIC loads connecting neighboring patches 302, the non-Foster constraints on the surface impedance are broken. The simplest NIC design with such desired functionality is based on a cross-coupled pair of transistors (i.e., bipolar junction transistors). However, to be able to tailor Z_{s,eq} to fit the optimal frequency dispersion X_{s,opt} over a broad range of frequencies, and at the same time ensuring that the underlying circuit is stable and practically feasible, a system-on-package (SOP) circuit design is proposed, including a network of passive, resistive and reactive components (metasurface).

Referring now to FIG. 4A, FIG. 4A illustrates a view of a patch or a horizontal strip array of metal cells 302 (FIG. 3A) in accordance with an embodiment of the present invention. As shown in FIG. 4A, the array of metal cells 302 is loaded with an arbitrary load (Z_{L}), which may be active (e.g., NICs, transistors, diodes) or passive (e.g., resistors, inductors, capacitors), or any combination. The period of each element is D with a spacing of w, where the loads are placed. Shown in the bottom of FIG. 4A is an equivalent transmission line model of such a loaded surface, which is modeled as a parallel combination of the loading and the unloaded surface.

Referring now to FIG. 4B, FIG. 4B illustrates the array of metal cells 302 (FIG. 3A) loaded with a series combination of the loads in accordance with an embodiment of the present invention. Shown in the bottom of FIG. 4B is an equivalent transmission line model of such a loaded surface.

Returning to FIG. 2A, FIG. 2A shows the calculated surface reactance (line 203) of the design of the present invention, including all parasitic effects expected in the realization of this metasurface. It is seen that the electromagnetic response can be well tailored to follow X_{s,opt} (line 201) over a broad frequency range from 0.4 GHz to 1.2 GHz (with a relative error less than 5%). Since the design requirement is to keep the SW below −20 dB, the optimized reactance does not follow X_{s,opt} at very low frequencies, at which the uncloaked cylinder scatters very little. FIG. 2A also illustrates the surface resistance of this active metasurface (line 203), verifying that the loss of the proposed non-Foster mantle cloak is small yet positive across all the considered frequency range. This ensures that the scattering response is stable, despite the presence of active elements, and that at the same time the cloak is reasonably low-loss. In this regard, it is stressed that the principles of the present invention are not aiming here at broadening a resonant response, which may inherently cause stability issues as in recent works on non-Foster impedance matching, but instead to suppress the overall scattering of a passive object, which is an inherently nonresonant process, more prone to remain unconditionally stable.

Returning to FIG. 2B, FIG. 2B shows the corresponding SW for the realistic NIC-loaded mantle cloak (line 206). The cloak provides a drastically improved bandwidth, much broader than an ideal passive cloak, with a normalized SW well suppressed below −15 dB up to approximately 900 MHz. For very low frequencies the NIC-loaded mantle cloak does induce slightly more scattering than an ideal non-Foster cloak, but in this region the object itself has a very low scattering signature because of its small electrical size.

FIGS. 5A-5D illustrate the far-field scatting pattern of the infinite dielectric cylinder 101 of FIG. 1 without cover (501), with the ideal non-Foster mantle cloak (line 502), with the NIC-loaded mantle cloak (line 503) and with the ideal passive cloak (line 504) for different frequencies of operation: 0.8 GHz (FIG. 5A), 0.65 GHz (FIG. 5B), 0.5 GHz (FIG. 5C) and 0.4 GHz (FIG. 5D) in accordance with an embodiment of the present invention.

Referring to FIGS. 5A-5D, the scattered fields are plotted in the same scale for fair comparison. It is evident that all cloaks provide excellent scattering suppression at the design frequency f₀ (FIG. 5A). However, if the far-field is observed to scatter away from the design frequency, the passive cloak displays poor performance, compared to the ideal non-Foster or NIC-loaded mantle cloaks. For lower frequencies, a passive cloak induces an even larger scattering than that of the uncloaked dielectric cylinder.

As the frequency increases, the performance of all cloaks deteriorates, due to the excitation of higher-order scattering harmonics, yet the active devices provide improved and more robust performance. The proposed NIC-loaded mantle cloak follows with good agreement the performance of the ideal, optimal mantle cloak, and therefore provides the best scattering suppression, achievable with a single metasurface over the whole frequency range of interest. Better results, and cloaking for larger objects, aiming at suppressing at the same time multiple scattering harmonics, may be achieved with a multilayer design. The proposed broadband cloak, whose operation covers the entire UHF band, may be of particular interest for a wide range of communication applications, beyond camouflaging. Since this technique allows the wave to enter the cloak and interact with the cloaked object, it may enable exciting applications, such as broadband cloaked sensing, non-invasive probing and low-interference communications.

The time-domain response of the proposed mantle cloaks of FIGS. 2A-2B was also analyzed for a short pulse excitation in FIGS. 6A-6D to show how the proposed active device may successfully realize a stable, invisible obstacle for short broadband pulsed excitation. FIG. 6A is a schematic diagram of the time-domain analysis of a cloaked cylinder in accordance with an embodiment of the present invention. Signals are detected by receivers placed in different positions along the z axis, considering the cases of: no cloak (FIG. 6B), NIC-loaded mantle cloaks (FIG. 6C) and the ideal passive cloak (FIG. 6D) in accordance with an embodiment of the present invention. The transient responses of a Gaussian pulse traveling in free space (shown in dashed lines) are also shown for comparison.

Referring to FIGS. 6A-6D, four receivers 601A-601D are placed in different positions along the z axis, as shown in FIG. 6A. Receivers 601A-601D may collectively or individually be referred to as receivers 601 or receiver 601, respectively. While FIG. 6A illustrates four receivers 601, any number of receivers 601 may be placed along the z axis to acquire data. The distance dᵢ between the i-th receiver/processor R_{x,i} and the origin (center of the cylinder) is d₁=−16α, d₂=−6α, d₃=1.5α and d₄=6α. Therefore, Rₓ₁ 601A and Rₓ₂ 601B are hit by the impinging signal before the object, whereas Rₓ₃ 601C and Rₓ₄ 601D are placed behind the object.

FIGS. 6B-6D are graphs illustrating the signals detected by receivers 601 placed in different positions along the z axis, considering the cases of: no cloak (FIG. 6B), NIC-loaded mantle cloaks (FIG. 6C) and the ideal passive cloak (FIG. 6D), respectively, in accordance with an embodiment of the present invention. In particular, FIGS. 6B-6D show the calculated transient responses at the different receivers 601 for a short Gaussian pulse with frequency components 0.02-0.9 GHz traveling in free-space, comparing the received signals with (solid lines) and without (dashed lines) the cylindrical scatterer. Different scattering scenarios are considered: the uncloaked cylinder (FIG. 6B), the NIC-loaded mantle cloak (FIG. 6C), and the ideal passive mantle cloak (FIG. 6D). It is seen that the proposed NIC-loaded non-Foster cloak suppresses most of the signal distortion and reflections behind the object. The short pulse shape is restored to the one in absence of the cylinder, both behind and passed the object, implying that its overall bandwidth performance is excellent and stability is preserved, despite the active elements in the cloak. Both the uncloaked and the passive-cloak, on the contrary, show severely distorted signals, dispersed and delayed in time, as it is particularly obvious for signals received by Rₓ₁ 601A and Rₓ₂ 601B. The passive cloak slightly improves transmission, since it cancels the scattering around f₀. However, the remaining frequency components contribute to distorting and stretching the tail and precursor of the signal, due to the relatively narrow cloaking bandwidth. In other words, the passive cloak can be easily detected when excited by a short pulse, while the proposed active cloak has a much more robust performance.

Returning to FIGS. 3A-3C, in one embodiment, the circuit element 304 in each of the metal cells 302 may be tunable thereby actively tuning electromagnetic invisibility cloaking device 300 based on frequency as discussed below in connection with FIGS. 7A-7C and 8-9.

Referring to FIGS. 7A-7C, in conjunction with FIGS. 1 and 3A-3C, FIGS. 7A-7C illustrate a finite-length conductive rod 701 covered by metasurface 301 loaded with tunable circuit elements 303 in accordance with an embodiment of the present invention. As illustrated in FIG. 7A, rod 701 includes an object 101 that corresponds to a finite-length conductive rod covered by an ultrathin metasurface 301 loaded with voltage (V,) tunable electronics 303 (diodes in this case). The thin and conformal metasurface 301 here is backed by a dielectric substrate spacer, which may be tailored to have various thicknesses. FIG. 7B further illustrates an exploded equivalent circuit diagram 702 of the tunable reverse-biased diode (Cⱼ), including realistic packaging parasitics (R_{S}, C_{P}, L_{S}), which may also be exploited for a wide range of equivalent surface impedance values, depending on the object to be concealed as shown in FIG. 7B. FIG. 7C additionally illustrates a realistic printed circuit board (PCB) 703 with an integrated power source and tunable resistor for frequency adjustment. This cut view is of the PCB inserted inside a hollow piece of ¾″ electrical conduit.

Referring to FIG. 8, in conjunction with FIGS. 7A-7C, FIG. 8 is a graph 800 illustrating an example of the wideband tunability of the cloaked finite-length conductive rod 701 in accordance with an embodiment of the present invention. By changing the voltage across the circuit (V_{R}) (ranging from 2.3 volts to 15 volts), the scattering of the conductive rod 701, integrated over all angles, is suppressed by 75% over a bandwidth of better than 1 GHz. Not shown here for clarity, by reducing the voltage towards 0 V, the frequency of operation can be lowered to below 2 GHz. The results shown here consider the realistic effects of packaging parasitics, including non-idealities, such as additional loss (R_{S}) and detuning effects (C_{P}, L_{S}).

Referring to FIG. 9, in conjunction with FIGS. 7A-7C, FIG. 9 illustrates the scattering patterns of cloaked rod 701 without cover and with the cloak (metasurface 301) as illustrated in FIG. 7A by applying several voltages (15 volts, 6 volts and 2.3 volts) to the loaded surface in accordance with an embodiment of the present invention. The patterns shown in FIG. 9 further demonstrate that the radiation pattern can be controlled by simply changing the bias voltage of the loaded surface to have extremely low backscattering (2.3 volts) or a much reduced total integrated radar cross section (RCS) (6 volts). Furthermore, covered conductive objects scattering predominantly magnetic-type radiation are envisioned (15 volts).

In conclusion, the concept and potential realization of a broadband and/or tunable mantle cloak, formed by a subwavelength metasurface loaded with optimal circuit elements, such as active NIC elements or tunable varactor diodes, has been proposed. It has been demonstrated with both time- and frequency-domain analysis that drastic scattering reduction is achievable over a broad frequency range using an inherently stable, active non-Foster mantle cloak. It is envisioned that this low-profile and broadband cloaking technology may be applied to several applications of interest at radio frequency (RF) and microwaves, including camouflaging and invisibility, low-invasive sensing and low-noise communications. It is believed that the use of active circuitry in radio-frequency cloaks is the ideal route to significantly broaden the cloaking bandwidth and make a significant impact on applications. While the preceding discussion focuses on mantle cloaks, whose platform is ideal for circuit loading, the exciting effects may be also observed by loading with non-Foster circuit elements other cloaking platforms, such as transformation-based or transmission-line cloaks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An electromagnetic invisibility cloaking device, comprising:
an object; and
a metasurface comprising an array of metal cells, wherein one or more of said metal cells comprises a circuit element, wherein said metasurface conforms to a surface design of said object.

2. The electromagnetic invisibility cloaking device as recited in claim 1, wherein said object to be cloaked is an antenna.

3. The electromagnetic invisibility cloaking device as recited in claim 1, wherein said object is cylindrical in shape.

4. The electromagnetic invisibility cloaking device as recited in claim 1, wherein said circuit element is a passive device.

5. The electromagnetic invisibility cloaking device as recited in claim 1, wherein said circuit element is an active device.

6. The electromagnetic invisibility cloaking device as recited in claim 1, wherein said circuit element comprises a negative impedance converter element.

7. The electromagnetic invisibility cloaking device as recited in claim 6, wherein said negative impedance converter element corresponds to a one-port op-amp circuit acting as a negative load.

8. The electromagnetic invisibility cloaking device as recited in claim 6, wherein said negative impedance converter element corresponds to a semiconductor circuit acting as a negative load.

9. The electromagnetic invisibility cloaking device as recited in claim 1, wherein said circuit element comprises one of the following: a variable capacitor, a varactor diode, a variable inductor or a combination of the preceding.

10. The electromagnetic invisibility cloaking device as recited in claim 1, wherein said array of metal cells corresponds to an array of metal square patches.

11. The electromagnetic invisibility cloaking device as recited in claim 1, wherein said array of metal cells corresponds to a mesh grid.

12. The electromagnetic invisibility cloaking device as recited in claim 11, wherein each opening in said mesh grid includes said circuit element.

13. The electromagnetic invisibility cloaking device as recited in claim 1, wherein said object is a dielectric cylinder.

14. The electromagnetic invisibility cloaking device as recited in claim 1, wherein said object is made of dielectric material.

15. The electromagnetic invisibility cloaking device as recited in claim 14, wherein said metasurface is made of a combination of said dielectric material and said metal.

16. The electromagnetic invisibility cloaking device as recited in claim 1, wherein each of said one or more metal cells is tunable.
